(19) United States
(12) Patent Application Publication
(10) Pub. No.: US 2023/0422142 A1
(43) Pub. Date: Dec. 28, 2023

(54) Collaboration Between Mobile Network Operators for Mobile Edge Computing Applications

(71) Applicant: Huawei Technologies Co., Ltd., Shenzhen (CN)

(72) Inventors: Siva Vakeesar, Kista (SE); Andrey Krendzel, Kista (SE); Ali Hamidian, Kista (SE); Seil Jeon, Kista (SE); Antonio Consoli, Kista (SE)

(21) Appl. No.: 18/463,615

(22) Filed: Sep. 8, 2023

Related U.S. Application Data
(63) Continuation of application No. PCT/EP2021/056211, filed on Mar. 11, 2021.

(51) Int. Cl. H04W 40/20

(52) U.S. Cl. CPC H04W 40/20

(57) ABSTRACT

Configuration data associated with data traffic of at least one user equipment at a geographical area may be obtained at a home public land mobile network. The configuration data may comprise a mapping of the data traffic to an identifier of at least one co-located public land mobile network configured to provide access to an edge application server at the geographical area. The home public land mobile network may cause routing of the data traffic to the co-located public land mobile network based on the configuration data.

### CROSS-REFERENCE TO RELATED APPLICATIONS

This is a continuation of Int'l Patent App. No. PCT/EP2021/056211, filed on Mar. 11, 2021, which is incorporated by reference.

### FIELD

Various example embodiments generally relate to the field of communication networks. In particular, some example embodiments relate to routing data traffic for mobile edge computing in wireless communication networks.

### BACKGROUND

Communication networks may apply multi-access edge computing (MEC) that allows computing tasks to be processed and executed in appropriate edge application servers (EASs) located relatively close to a user equipment (UE). However, all mobile network operators (MNOs) may not have similar MEC infrastructures and other resources to serve the UE.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective of the present disclosure to enable a UE to access an edge application server of another public land mobile network (PLMN) through the radio access network of a home PLMN of the UE. The foregoing and other objectives may be achieved by the features of the independent claims. Further implementation forms are apparent from the dependent claims, the description, and the drawings.

According to a first aspect, a network node for data traffic routing is provided. The network node may be configured to: obtain, at a home public land mobile network, configuration data associated with data traffic of at least one user equipment at a geographical area, the configuration data comprising a mapping of the data traffic to an identifier of at least one co-located public land mobile network configured to provide access to an edge application server at the geographical area; and cause routing of the data traffic to the co-located public land mobile network based on the configuration data. This solution enables access to an edge application server of a co-located PLMN through a home PLMN.

According to an implementation form of the first aspect, the network node may be further configured to receive an application function request from an application function, the application function request comprising the configuration data. This solution enables external configuration of the data traffic routing to the edge application server of the co-located PLMN.

According to an implementation form of the first aspect, the network node may be further configured to identify the data traffic based on at least one of a data network name, a single network slice selection assistance information value, or an application function service identifier. This solution enables to configure the routing to the edge application server of the co-located PLMN for particular data traffic.

According to an implementation form of the first aspect, the configuration data may further comprise, for the co-located public land mobile network, at least one of at least one supported data network name, at least one supported data network access identifier, at least one traffic routing requirement for the at least one supported data network access identifier, a fully qualified domain name of the edge application server, an Internet protocol address of the edge application server, and a requirement for routing the data traffic through a shortest path to the edge application server via a user plane function of the home public land mobile network. This solution enables selection of an appropriate co-located PLMN.

According to an implementation form of the first aspect, the network node may comprise a network exposure function of the home public land mobile network.

According to an implementation form of the first aspect, the network node may comprise a policy control function of the home public land mobile network.

According to an implementation form of the first aspect, the network node may be further configured to: determine, based on the configuration data, policy and charging control rules for a session management function of the home public land mobile network for selecting a user plane function of the co-located public land mobile network for routing the data traffic to the edge application server; and provide the policy and charging control rules to the session management function of the home public land mobile network. This solution enables the configuration of the home PLMN and the co-located PLMN by a session management function of the home PLMN to enable routing of the data traffic to the edge application server of the co-located PLMN.

According to an implementation form of the first aspect, the policy and charging control rules may comprise a mapping between the at least one supported data network access identifier and the identifier of the co-located public land mobile network for a given service data flow (SDF) that can be identified, for example, by a service data flow template. This solution enables a session management function of the home PLMN to determine an appropriate user plane function of the co-located PLMN for routing the data traffic to the edge application server of the co-located PLMN with a help of a session management function belonging to the co-located PLMN.

According to an implementation form of the first aspect, the network node may be further configured to: determine, based on the configuration data, access and mobility related policy information for an access and mobility management function of the home public land mobile network for selecting a session management function of the co-located public land mobile network, the session management function configured to manage at least one packet data unit session associated with the data traffic; and provide the access and mobility related policy information to the access and mobility management function of the home public land mobile network. This solution enables configuration of the home PLMN to enable selection of an appropriate session management function of the co-located PLMN to enable routing the data traffic to the edge application server of the co-located PLMN.

According to an implementation form of the first aspect, the access and mobility related policy information may comprise an indication of at least one allowed co-located public land mobile network associated with at least one tracking area identifier for a given user equipment. This solution enables an access and mobility management function of the home PLMN to select a co-located PLMN that is available for routing of the data traffic to the edge application server within a tracking area.

According to an implementation form of the first aspect, the access and mobility related policy information may further comprise an indication of at least one supported single network slice selection assistance information value per co-located public land mobile network associated with the at least one tracking area identifier, in order to route a given traffic type of a user equipment. This solution may further improve selection of the co-located PLMN within the tracking area.

According to an implementation form of the first aspect, the access and mobility related policy information may further comprise a mapping between the identifier of the co-located public land mobile network and one of the at least one supported data network name and the at least one supported data network access identifier. This solution enables selection of a co-located PLMN that supports routing the data traffic of a given type originating from a user equipment to the edge application server.

According to an implementation form of the first aspect, the configuration data further comprises, for the co-located public land mobile network, at least one data network name, and the network node may be further configured to: determine user equipment route selection policy information comprising a request for external routing of the data traffic through the co-located public land mobile network, the user equipment route selection policy information further comprising at least one route selection descriptor comprising at least one single network slice selection assistance information value or the at least one data network name of the home public land mobile network, and a mapping between the at least one tracking area identifier or at least one registration area identifier and the at least one single network slice selection assistance information value or the at least one data network name of the co-located public land mobile network; and cause transmission of the user equipment route selection policy information to the at least one user equipment. This solution enables configuring a user equipment for establishing a communication session with the edge application server of the co-located PLMN through the home PLMN at a particular geographical area.

According to a second aspect, a network node for data traffic routing is provided. The network node may be configured to: receive, from the at least one user equipment, a registration request comprising at least one of a mapping between at least one single network slice selection information value of requested network slice selection assistance information of the home public land mobile network and at least one single network slice selection information value of the co-located public land mobile network, and a request for local area data network information of the co-located public land mobile network; retrieve, from a unified data management function or a unified data repository function of the home public land mobile network at least one of a mapping of allowed or configured network slice selection information between the home public land mobile network and the co-located public land mobile network, the local area data network information for the co-located public land mobile network, and a list of a plurality of co-located public land mobile networks per geographical area; and cause transmission of a registration accept message to the at least one user equipment, the registration accept message comprising at least one of the mapping of allowed or configured network slice selection information between the home public and mobile network and the co-located public land mobile network, the local area data network information for the co-located public land mobile network, and the list of the plurality of the co-located public land mobile networks per geographical area. This solution enables registering a user equipment and configuration of the user equipment for establishing a communication session with the edge application server via one of a plurality of available co-located PLMNs through the radio access network of the home PLMN at a geographical area.

According to an implementation form of the second aspect, the network node may comprise an access and mobility management function of the home public land mobile network.

According to an implementation form of the second aspect, the network node may be further configured to: provide, to a network repository function of the home public land mobile network, a network function discovery request comprising the identifier of the co-located public land mobile network and at least one single network slice selection assistance information value of the co-located public land mobile network associated with the data traffic; and receive a network function discovery request response comprising an identifier of the session management function of the co-located public land mobile network. This solution enables the home PLMN to select an appropriate session management function of the co-located PLMN for controlling routing of the data traffic to the edge application server of the co-located PLMN.

According to a third aspect, a network node for data traffic routing is provided. The network node may be configured to receive, from the at least one user equipment, a packet data unit session establishment request comprising: a single network slice selection assistance information value and a data network name of the home public land mobile network, a single network slice selection assistance information value and a data network name of the co-located public land mobile network, and a request for external routing through the co-located public land mobile network; and establish the packet data unit session based on the packet data unit session establishment request. This solution enables a user equipment to request establishment of a communication session for routing the data traffic to the edge application server of the co-located PLMN through the home PLMN.

According to an implementation form of the third aspect, the network node may comprise a session management function of the home public land mobile network.

According to an implementation form of the third aspect, the network node may be further configured to select the user plane function of the home public land mobile network for routing the data traffic to the co-located public land mobile network based of the configuration data. This solution enables the configuration of the home PLMN to enable routing of the data traffic to the edge application server of the co-located PLMN.

According to an implementation form of the third aspect, the network node may be further configured to: transmit, to the session management function of the co-located public land mobile network, a packet data unit session create request comprising the single network slice selection assistance information value and the data network name of the co-located public land mobile network; receive, from the session management function of the co-located public land mobile network, a packet data unit session create request response comprising at least one of the Internet protocol address of the edge application server, the qualified domain name of the edge application server, an Internet protocol address of a domain name system server, and a qualified domain name of the domain system server; and cause transmission of a packet data unit session establishment accept message to the at least one user equipment, the packet data unit session establishment accept message comprising at least one of the Internet protocol address of the edge application server, the fully qualified domain name of the edge application server, the Internet protocol address of the domain name system server, and the fully qualified domain name of the domain system server. This solution enables the establishment of a communication session for routing the data traffic of a user equipment of the home PLMN to the edge application server of the co-located PLMN.

According to a fourth aspect, a network node for accessing an edge application server of a co-located public land mobile network is provided. The network node may be configured to: transmit a packet data unit session establishment request comprising a single network slice selection assistance information value and a data network name of a home public land mobile network, a single network slice selection assistance information value and a data network name of the co-located public land mobile network, and a request for external routing through the co-located public land mobile network; receive a packet data unit session establishment accept message comprising at least one of an Internet protocol address of the edge application server, a fully qualified domain name of the edge application server, the Internet protocol address of a domain name system server, and a fully qualified domain name of the domain system server; and communicate data traffic with the edge application server maintaining connection with the co-located public land mobile network through a base station of the home public land mobile network using an established packet data unit session. This solution enables the device to request the establishment of a communication session for routing the data traffic of the user equipment to an edge application server of the co-located PLMN through the home PLMN.

According to an implementation form of the fourth aspect, the network node may be further configured to: transmit a registration request comprising at least one of a mapping between at least one single network slice selection information value of requested network slice selection assistance information of a home public land mobile network and at least one single network slice selection information value of the co-located public land mobile network, and a request for local area data network information of the co-located public land mobile network; and receive a registration accept message comprising at least one of a mapping of allowed or configured network slice selection information between the home public land mobile network and the co-located public land mobile network, the local area data network information for the co-located public land mobile network, and a list of a plurality of co-located public land mobile networks per geographical area. This solution enables the device to register to the home PLMN and be configured for requesting the establishment of the communication session for routing the data traffic of the user equipment to the edge application server of the co-located PLMN through the home PLMN.

According to an implementation form of the fourth aspect, the network node comprises a user equipment.

According to a fifth aspect, a network node for enabling routing of data traffic is provided. The network node may be configured to: receive, from an application function configured to interact with a co-located public land mobile network, data traffic routing information comprising at least one of routing information of an interface between a user plane function of a home public land mobile network and a user plane function of the co-located public land mobile network for routing data traffic at a geographical area, a list of supported data network access identifiers of the co-located public land mobile network at the geographical area, a list of supported single network slice selection assistance information values and data network names at the geographical area for at least one application function service identifier, and mapping information between non-standardized single network slice selection assistance information values of the home public land mobile network and the co-located public land mobile network; and provide the data traffic routing information to an application function configured to interact with the home public land mobile network. This solution enables sharing of data traffic routing information between a home PLMN and a co-located PLMN for routing data traffic to an edge application server of the co-located PLMN through the home PLMN.

According to a sixth aspect, a method for data traffic routing is provided. The method may comprise: obtaining, at a home public land mobile network, configuration data associated with data traffic of at least one user equipment at a geographical area, the configuration data comprising a mapping of the data traffic to an identifier of at least one co-located public land mobile network providing access to an edge application server at the geographical area; and causing routing of the data traffic to the co-located public land mobile network based on the configuration data. This solution enables access to an edge application server of a co-located PLMN through a home PLMN.

According to a seventh aspect, a method for data traffic routing is provided. The method may comprise: receiving, from at least one user equipment, a registration request comprising at least one of a mapping between at least one single network slice selection information value of requested network slice selection assistance information of the home public land mobile network and at least one single network slice selection information value of the co-located public land mobile network, and a request for local area data network information of the co-located public land mobile network; retrieving, from a unified data management function or a unified data repository function of the home public land mobile network, at least one of a mapping of allowed or configured network slice selection information between the home public land mobile network and the co-located public land mobile network, the local area data network information for the co-located public land mobile network, and a list of a plurality of co-located public land mobile networks per geographical area; and causing transmission of a registration accept message to the at least one user equipment, the registration accept message comprising at least one of the mapping of allowed or configured network slice selection information between the home public land mobile network and the co-located public land mobile network, the local area data network information for the co-located public land mobile network, and the list of the plurality of the co-located public land mobile networks per geographical area. This solution enables registering a user equipment and configuring the user equipment for establishing a communication session with the edge application server via one of a plurality of available co-located PLMNs through the radio access network of the home PLMN at a geographical area.

According to an eighth aspect, a method for data traffic routing is provided. The method may comprise: receiving, from the at least one user equipment, a packet data unit session establishment request comprising a single network slice selection assistance information value and a data network name of the home public land mobile network, a single network slice selection assistance information value and a data network name of the co-located public land mobile network, and a request for external routing through the co-located public land mobile network; and establishing the packet data unit session based on the packet data unit session establishment request. This solution enables a user equipment to request the establishment of a communication session for routing the data traffic to the edge application server of the co-located PLMN through the home PLMN.

According to a ninth aspect, a method for accessing an edge application server of a co-located public land mobile network is provided. The method may comprise: transmitting a packet data unit session establishment request comprising a single network slice selection assistance information value and a data network name of a home public land mobile network, a single network slice selection assistance information value and a data network name of the co-located public land mobile network, and a request for external routing through the co-located public land mobile network; receiving a packet data unit session establishment accept message comprising at least one of an Internet protocol address of the edge application server, a fully qualified domain name of the edge application server, the Internet protocol address of a domain name system server, and a fully qualified domain name of the domain system server; and communicating data traffic with the edge application server using an established packet data unit session. This solution enables requesting the establishment of a communication session for routing the data traffic of a user equipment to an edge application server of the co-located PLMN through the home PLMN.

According to a tenth aspect, a method for enabling routing of data traffic is provided. The method may comprise: receiving, from an application function configured to interact with a co-located public land mobile network, data traffic routing information comprising at least one of routing information of an interface between a user plane function of a home public land mobile network and a user plane function of the co-located public land mobile network for routing data traffic at a geographical area, a list of supported data network access identifiers of the co-located public land mobile network at the geographical area, a list of supported single network slice selection assistance information values and data network names at the geographical area for at least one application function service identifier, and mapping information between non-standardized single network slice selection assistance information values of the home public land mobile network and the co-located public land mobile network; and providing the data traffic routing information to an application function configured to interact with the home public land mobile network. This solution enables sharing of data traffic routing information between a home PLMN and a co-located PLMN for routing data traffic to an edge application server of the co-located PLMN through the home PLMN.

According to an eleventh aspect, a computer program is provided. The computer program may comprise program code configured to cause performance of any implementation form of the method of the sixth, seventh, eighth, ninth, or tenth aspect, when the computer program is executed on a computer.

Implementation forms of the present disclosure can thus provide devices, methods, and computer programs for enabling routing of data traffic to an edge application server of another PLMN. Any implementation form may be combined with one or more other implementation forms. These and other aspects of the present disclosure will be apparent from the example embodiment(s) described below.

### BRIEF DESCRIPTION OF THE DRAWINGS

The accompanying drawings, which are included to provide a further understanding of the example embodiments and constitute a part of this specification, illustrate example embodiments and, together with the description, help to explain the example embodiments. In the drawings:

FIG. 1 illustrates an example of a communication system with two mobile network operators, according to an embodiment of the present disclosure;

FIG. 2 illustrates an example of a device configured to practice one or more embodiments of the present disclosure;

FIG. 3 illustrates an example of a user equipment registration procedure, according to an embodiment of the present disclosure;

FIG. 4 illustrates an example of a network function service discovery procedure across two public land mobile networks, according to an embodiment of the present disclosure;

FIG. 5 illustrates an example of network functions of a home public land mobile network and a co-located public land mobile network, according to an embodiment of the present disclosure;

FIG. 6 illustrates an example of a packet data unit session establishment procedure, according to an embodiment of the present disclosure;

FIG. 7 illustrates an example of two public land mobile networks and a federated application function manager, according to an embodiment of the present disclosure;

FIG. 8 illustrates an example of a method for data traffic routing, according to an embodiment of the present disclosure;

FIG. 9 illustrates an example of a method for accessing an edge application server of a co-located public land mobile network, according to an embodiment of the present disclosure;

FIG. 10 illustrates an example of a method for enabling routing of data traffic, according to an embodiment of the present disclosure;

FIG. 11 illustrates an example of a method for data traffic routing, according to an embodiment of the present disclosure; and

FIG. 12 illustrates an example of a method for data traffic routing, according to an embodiment of the present disclosure.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

MEC may be considered as an enabler of the fifth generation (5G) or other future networks that allows computing tasks to be processed and executed in appropriate EASs located in close proximity of a UE. A tenet of this approach is that data generated locally, for example, in a vehicle-to-everything (V2X) situation, may be relevant to a particular geographical area given the time urgency of most safety critical applications. For example, vehicular or pedestrian movements may be processed locally and the results may be passed on to appropriate road users in a timely manner in order to ensure effectiveness of any locally collected/processed data, for instance, to avoid an accident.

Cooperative maneuvers, for example, in the case of emergency trajectory alignment between UEs supporting a V2X application, may require that the communication system supports message exchange with a maximum end-to-end latency of 3 ms between a host vehicle and a remote vehicle, when the vehicles are driven at an absolute speed of up to 130 km/h, while supporting data rate of 30 Mbps. This may enable an application server to process data from one or more remote vehicles sufficiently quickly before passing the processed data to an appropriate host vehicle. The application server may decide which data from which remote vehicles are relevant to which host vehicle. These requirements demonstrate the benefits of MEC in ensuring high reliability and high availability of MEC-V2X application services. In the case of, for instance, cooperative collision avoidance, in order to meet high-speed and low-latency requirements, it may be therefore beneficial to have an application server located locally (i.e., not remotely).

One of the impending factors delaying fully-fledged V2X or intelligent transport system (ITS) deployment is the fact that not every mobile network operator (MNO) may have necessary MEC infrastructures and other resources, e.g., road side units (RSUs), in every part of a given country. This may be the case, for example, with Tier-2 operators that may not have deployed necessary resources everywhere due to financial, regulatory, or operational constraints. Another impending factor is that in a road traffic situation vehicles may belong to different car original equipment manufacturers (OEMs) that may have agreements mainly with a single MNO. For example, a car OEM C1 may use subscriber identity modules (SIMs) belonging to a first MNO (MNO 1) in its vehicles. Another car OEM C2 may use SIMs belonging to a second MNO (MNO 2). Similarly, vulnerable road users (VRUs) and RSUs of an ITS may be connected to different MNOs. Thus, the lifeline of a V2X scenario may depend on how much different MNOs collaborate with each other, for instance, in terms of sharing of MEC resources. There are various use cases in which MEC resource sharing may be useful, for example, when a home public land mobile network (HPLMN) requires to seek assistance of a co-located PLMN, referred to herein as a CPLMN, for the purpose of serving its own UE using its own base station, for example, a gNB in a 5G network. It is noted that such use cases may not involve any roaming. The “co-located” PLMN may comprise a PLMN that is different from the HPLMN, but which is not a visitor PLMN (VPLMN) used for roaming. The CPLMN may be co-located with the HPLMN. For example, service areas of the CPLMN and HPLMN may be at least partially overlapping such that an edge application server of the CPLMN may be accessed through a base station of the HPLMN.

In the 5G system (5GS), at the time of roaming, the VPLMN may determine the identity of an HPLMN associated with a UE using the subscription permanent identifier (SUPI) of the UE. However, given that in the considered use cases the HPLMN may seek assistance of another PLMN, it may be beneficial to provide a way for the HPLMN to know that for a given (MEC) application in a given geographical location, the HPLMN should seek assistance of an CPLMN in order to serve its own UE, for example, to route UE traffic to an appropriate EAS. The embodiments of the present disclosure describe how an HPLMN may be informed about the identity of at least one appropriate CPLMN to quickly enlist network functions (NFs) belonging to the CPLMN in order to support a given MEC application in a given geographical location. Since the use of CPLMN may not involve roaming, the HPLMN may be informed about potential application locations on a per CPLMN granularity basis. For this purpose, an application function (AF) request to the 5G core network (5GC) associated with the HPLMN may comprise an indication of which co-located PLMN identifier (PLMN-ID) is to be used for given UE data traffic, which may be identified, for example, by a single network slice selection assistance information (S-NSSAI) value, AF Service Identifier, or an application ID in a given geographical area. Corresponding information may be considered in at least:
i. external parameter provisioning (using, for example, Nnef_ParameterProvision_Create/Nnef_ParameterProvision_Update operation) happening between AF and network exposure function (NEF)/a policy control function (PCF)/unified data manager (UDM)—this can be alternatively handled by an AF through Nnef_TrafficInfluenceCreate/Update/Delete Request targeting an individual UE address to the NEF and the same applies throughout the description,
ii. Registration Request taking place between UE and AMF,
iii. packet data unit (PDU) Session Establishment happening between UE and SMF,
iv. UE route selection policy (URSP) configuration happening between UE and PCF,
v. dynamic policy and charging control (PCC) creation and exchange between PCF and SMF,
vi. Access mobility management related policy creation and exchange between a PCF and an AMF,
vii. inter-MNO interactions between AMF and NRF to find appropriate C-SMF, and
viii. exchange of information between two AF instances with or without a help of a federated manager.

The embodiments of the present disclosure may enable addressing at least the following issues:
notification to a HPLMN of potential locations of applications on a per (C)PLMN granularity such that the HPLMN is enabled to enlist resources associated with a selected CPLMN in order to appropriately route respective data traffic when its own UE invokes a given (MEC) Application,
indication of the potential application locations by an application function belonging to a particular road traffic authority (RTA),
determining, by an AMF or SMF of the HPLMN, how to locally route the data traffic by selection of appropriate UPFs,
informing an AMF of the HPLMN of a need to enlist an SMF of an CPLMN to serve a UE of the HPLMN using a gNB of the HPLMN,
selection of the SMF of the CPLMN and determining a PLMN-ID to be included in its network repository function (NRF) or network slice selection function (NSSF) query,
routing of the data traffic by the SMF of the HPLMN,
configuration of a UE in terms of what S-NSSAI(s) are allowed in both the HPLMN and CPLMN and configuration of S-NSSAI mapping between the HPLMN and CPLMN,
provision of the S-NSSAI mapping in case of non-standardized S NSSAI as part of UE Configuration Update,
determining a URSP configuration for the data traffic routing to the CPLMN,
indication, by a UE, of S-NSSAI(s) to be used in both HPLMN and CPLMN and a need to create localized path at the time of PDU session establishment, and
information elements to be included in a PDU session establishment procedures.

For the signalling-based embodiments disclosed herein, one or more of the following system characteristics may apply:
An RTA may be an government entity bringing together different car OEMs and MNOs/PLMNs while encouraging/enforcing resource sharing in order to ensure fully-fledged ITS deployment. The term MNO and PLMN are used interchangeably.
It is possible that not every MNO has required MEC infrastructure in every part of a country due to financial, regulatory and economic reasons preventing fully-fledged V2X operations.
Relevant SLAs may be in place among RTA(s), RSU operators, car OEMs and MNOs.
The RTA may operate one or many AF instances to enable AF-influenced traffic steering to ensure inter-MNO resource sharing.
Different AF instances belonging to an RTA may interact with both the HPLMN having no respective MEC infrastructure and a CPLMN having the required MEC infrastructure.
The AF instances may be located centrally—hence, the HPLMN having no MEC infrastructure may get required AF inputs in terms of potential application location per CPLMN granularity.
AFs belonging to the RTA may gather the information about the potential application locations per CPLMN granularity by any suitable manner.
An AF belonging to the RTA may interact with MNO-1 (CPLMN) and MNO 2 (HPLMN) to generate policy rules, which may be used, for instance, to enforce forwarding action rule(s) (FAR).
An appropriate PDU session may be established to the correct localized data network while making use of localized UPFs.
Given stringent latency requirements of V2X applications, e.g. for lane merging, and the possible need to locally process locally generated multimedia traffic because of its local relevance, use of EAS may be preferred over use of any centralized application server (AS). Hence, use of localized MEC infrastructure may be enabled.
When a high-speed vehicle generates multimedia traffic pertaining to, e.g., a lane merging application, in order to ensure minimal latency, it may be desired to utilize localized MEC infrastructure for a quick processing even if it requires different MNO support.

While taking the above characteristics into consideration, one or more of the following aspects may be considered to address the issues identified above:
configuration of AF request(s) to indicate what CPLMN-ID to use for a given Application ID per TA per HPLMN at a given time period,
configuration of PCC rule to ensure corresponding accessing, routing and charging behaviour—e.g., indication that a PSA UPF is located in an CPLMN,
configuration of URSP for a UE to indicate two sets of S-NSSAI/DNN (data network name) pairs, one set for the HPLMN and another set for the CPLMN,
configuration of a UE registration request with inclusion of allowed S NSSAI(s) per CPLMN, request for local area data network (LADN) information per CPLMN, and/or coverage requirements in terms of a tracking area of the HPLMN in relation to a registration area (RA), and
configuration of the PDU session establishment procedure such that only an AMF belonging to the HPLMN is in use, allowing interactions between SMFs of the HPLMN and the CPLMN and UPFs of the HPLMN and the CPLMN. The above features will be further described below.

According to an embodiment of the present disclosure, configuration data associated with data traffic of at least one UE at a geographical area may be obtained at a HPLMN. The configuration data may be passed on to the 5GC by an AF using operations such as, for example, Nnef_ParameterProvision_Create, nef_ParameterProvision_Update, or Nnef_TrafficInfluenceCreate/Update/Delete Request targeting an individual UE address to the NEF. The configuration data may comprise a mapping of the given data traffic to an identifier of at least one co-located PLMN (for example, the CPLMN) configured to provide access to an EAS at the geographical area. The HPLMN may cause routing of the data traffic to the co-located PLMN based on the configuration data. This enables HPLMN routed access to the EAS of the co-located PLMN.

FIG. 1 illustrates an example of a communication system with two mobile network operators, according to an embodiment of the present disclosure. One or more devices, such as for example UEs 110, 112, 114, may communicate with radio access networks (RANs) comprising one or more base stations, represented in this example by two fifth generation base stations (gNB). A first gNB (gNB 1) may belong to a first MNO (CPLMN 140). A second gNB (gNB 2) may belong to a second MNO (HPLMN 130). The base stations may be also called radio access network nodes. The UEs 110, 112, 114 may communicate with the respective gNBs over an air interface, for example, as specified in the 5G NR (new radio) standard.

The gNBs may be connected to one or more user plane functions (UPFs), for example, by an N3 interface. The gNB 1 may be connected to a local UPF of the CPLMN 140 (C-UPF). The gNB 2 may be connected to a local UPF of the HPLMN 130 (H-UPF). A UPF may be configured to take care of the user data part of a communication session. For example, a UPF may be configured to encapsulate and decapsulate PDUs of the user plane (UP), for example, the General Packet Radio Service (GPRS) tunnelling protocol for the user plane (GTP-U). A UPF may operate as a PDU session anchor (PSA) UPF that terminates an N6 interface of a PDU session in the 5G network. The Local UPF 1 may communicate with the Local UPF 2 over an UPF interface, such as for example an N9 interface.

An access and mobility management function (AMF, not depicted in FIG. 1) may receive connection and session request related data from a UE or a gNB, for example, over the N1 and N2 interfaces, respectively (cf. FIG. 5). An AMF may be configured to control access and mobility management in the network. An AMF may however delegate any session management related duties to a session management function (SMF). For example, an AMF of the HPLMN 130 may use an SMF (C-SMF) configured to manage communication session(s) in the CPLMN 140 whenever it sees that the PDU Session Establishment request contains additional S-NSSAI and DNN mapping for HPLMN and CPLMN or an explicit indication to involve CPLMN. An AMF of the HPLMN 130 may use an SMF (H-SMF) configured to manage communication session(s) in the HPLMN 130. It is however possible that an AMF of the HPLMN 130 is configured to enlist the C-SMF of the CPLMN 140 to serve its own UE 110 using its own gNB, for example, the gNB 2. Information about available SMF(s) may be obtained by querying an NRF, which may maintain information about services provided by various NFs.

An SMF, such as the C-SMF or the H-SMF, may be configured to manage one or more communication sessions, for example, PDU sessions, within one or more UPFs, for example, the C-UPF and/or the H-UPF. An SMF may communicate with an AMF, for example, to receive requests for establishment, update, or removal of communication sessions. An SMF may be configured to select a UPF for a PDU session. Information about available UPFs may be locally stored at an SMF or an SMF may retrieve this information from one or more other network functions, for example, the NRF.

The HPLMN 130 and CPLMN 140 may further comprise network exposure functions (H-NEF or C-NEF), policy control functions (H-PCF or C-PCF) and be connected to respective application functions (AF 2 or AF 1), which may be located outside the respective PLMN. The CPLMN 140 may be coupled to AF 1, which may provide an external application interface for interacting with network functions of the CPLMN 140. Similarly, the HPLMN 130 may be coupled to AF 2. The application functions may be controlled by a federated AF manager 150, as will be further described below. The PLMNs 130, 140 may also enable access to respective data networks (DNs).

The network functions may communicate over a service based interface (SBI) bus, which may be accessible to the different network functions. Interfaces between individual network functions, may be implemented over the SBI message bus. The HPLMN 130 and/or CPLMN 140 may further comprise other network functions such as for example a UDM function and/or a unified data repository function (UDR). An UDM may be configured to manage user data within a network. The UDM may be associated with an UDR, which may store user data such as customer profiles, subscription information, or other user related information.

In practical deployments, it is possible that not all MNOs, in this example MNO 2, have sufficient MEC infrastructure deployed everywhere, for example, due to financial, regulatory, and/or economic reasons. Hence, some MNOs may benefit from using MEC infrastructure of another operator, in this example MNO 1. Irrespective of such a scenario, a challenge may be on how to enable meaningful ITS interactions among various players such as multi-car OEMs, VRUs, or RSUs maintaining connections with different MNOs.

For example, embodiments of the present disclosure relate to the problem of how to enable the UE 110 (vehicle) that belongs to MNO 2 (HPLMN 130) having no (or insufficient) MEC infrastructure to utilize the MEC infrastructure of MNO 1 (CPLMN 140), for example, in order to enable the UE 112 belonging to MNO 1 to benefit from lane-merging video streams transmitted by the UE 110 as part of a V2X lane-merging application. In other words, the question is how to enable the HPLMN 130 (MNO 2) to make use of a PSA UPF (e.g. C-UPF) belonging to the CPLMN 140 (MNO 1) for the purpose of serving its own UE 110 while using its own base station (e.g. gNB 2).

As noted above, the co-located PLMN whose edge application server is utilized may be called a CPLMN to distinguish it from a VPLMN. This is because the embodiments of the present disclosure may not involve roaming and the terminology like VPLMN may be applied in the context of roaming. In a roaming scenario, a VPLMN and a HPLMN may interact with each other to serve a UE. Under such circumstances, a UE belonging to a HPLMN may roam into a region that is served by the VPLMN. In a roaming scenario, a base station belonging to the VPLMN may actually serve the roaming UE. On the other hand, according to embodiments of the present disclosure, the HPLMN 130 may request assistance from the CPLMN 140, which may be configured for provision of a required MEC application over its deployed MEC infrastructure, in order to serve the UE 110 of the HPLMN 130. Hence, the UE 110 belonging to the HPLMN 130 may not need to connect to base stations belonging to the CPLMN 140.

The HPLMN 130, whose base station (gNB 2) may directly serve the UE 110, may seek assistance of the CPLMN 140, which may provide a particular PSA UPF for the data traffic generated by the UE 110. Hence, the considered scenario may be different form a home-routed or local breakout (LBO) roaming scenario. Since roaming via a VPLMN is not involved, the base stations of the two PLMNs (gNB 1 and gNB 2) may be operating in the same geographical regions, i.e., collocating. Furthermore, UEs 110 and 112 may belong to the same car OEM or different car OEMs.

One option for configuring such as system is to manually configure PCF(s) with static PCC rules so that a PCF knows how to perform static routing pertaining to: policy and charging control rules to be provided to an SMF (comprising PCC rules and PDU session related attributes), access and mobility related control provided to the AMF, and/or UE access selection. However, a fully static configuration may require excessive human intervention and it may be expensive to manage a network while providing required ITS or V2X services in every corner of a service region. Furthermore, fully static configurations may not provide sufficient flexibility to dynamically deal with changing business, regulatory, or inter-MNO collaboration landscape. For instance, when an MNO deploys new MEC infrastructure in a given region, changes may need to be made to already statically made configurations. This may involve one or many MNOs and the challenging deployment may, for example, cause the fully-fledged deployment of ITS to be delayed. On the other hand, with a signalling-based or control-plane-based solution involving control-plane NFs of 5GC, different NFs may interact across MNO borders to exchange information. To enable this, appropriate service-level agreements (SLAs) may be required to be in place among collaborating MNOs, car OEMs, RSU owners, or the like.

Even though some embodiments have been described in the context of the 5G core network, it is appreciated that embodiments of the present disclosure are not limited to the particular examples and therefore the embodiments may be applied in any present or future communication networks. Furthermore, even though some embodiments are described using one CPLMN 140 as an example, it is appreciated that such embodiments may be generalized to a scenario with multiple available CPLMNs. For example, any signalling information described herein may be provided for multiple CPLMNs and the HPLMN may be configured to select one of the CPLMNs.

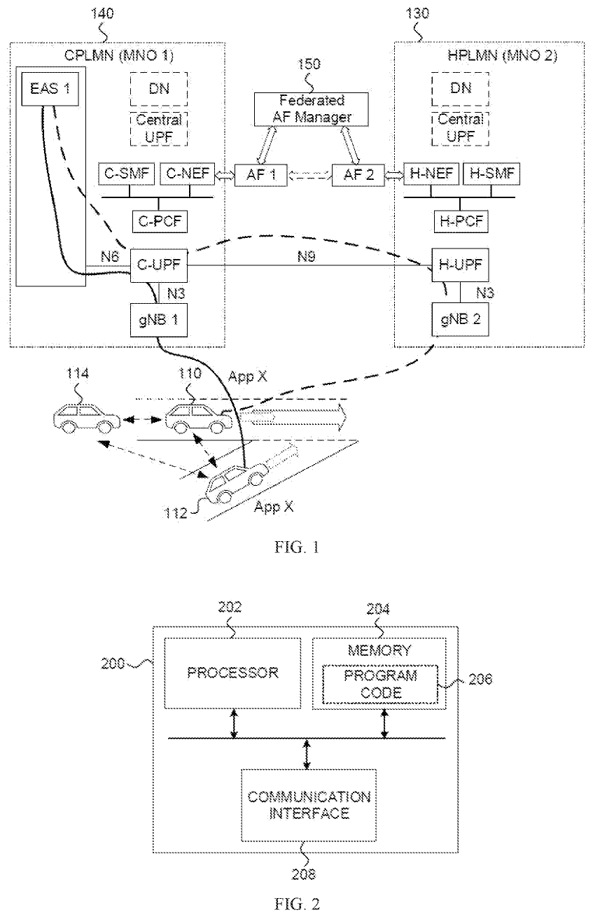

FIG. 2 illustrates an example of a device 200 configured to practice one or more embodiments. The device 200 may comprise a network device or a network node implementing one or more network functions, or a UE such as for example a mobile phone or a vehicle, or in general any device configured to implement any functionality described herein. The device 200 may comprise at least one processor 202. The at least one processor 202 may comprise, for example, one or more of various processing devices, such as, for example, a co-processor, a microprocessor, a controller, a digital signal processor (DSP), a processing circuitry with or without an accompanying DSP, or various other processing devices including integrated circuits such as, for example, an application-specific integrated circuit (ASIC), a field-programmable gate array (FPGA), a microcontroller unit (MCU), a hardware accelerator, a special-purpose computer chip, or the like.

The device 200 may further comprise at least one memory 204. The memory 204 may be configured to store, for example, computer program code or the like, for example, operating system software and application software. The memory 204 may comprise one or more volatile memory devices, one or more non-volatile memory devices, and/or a combination thereof. For example, the memory may be embodied as magnetic storage devices (such as hard disk drives, magnetic tapes, etc.), optical magnetic storage devices, or semiconductor memories (such as mask read-only memory (ROM), programmable ROM (PROM), erasable PROM (EPROM), flash ROM, random-access memory (RAM), etc.).

The device 200 may further comprise a communication interface 208 configured to enable the device 200 to transmit and/or receive information. The communication interface 208 may comprise an internal communication interface such as, for example, an interface (e.g. SBI) between different network functions of the device 200. Alternatively, or additionally, the communication interface 208 may be a reference point, for example N3 or N6. Alternatively, or additionally, the communication interface 208 may be configured to provide an external interface to another device, for example via the SBI. The communication interface may be further configured to provide a wireless radio connection, such as for example a 3rd Generation Partnership Project (3GPP) mobile broadband connection (e.g. 3G, 4G, 5G, or future generations), a wireless local area network (WLAN) connection such as for example standardized by IEEE 802.11 series or Wi-Fi alliance, or a short range wireless network connection such as for example a Bluetooth connection. The communication interface 208 may hence comprise one or more antennas to enable transmission and/or reception of radio frequency signals over the air.

When the device 200 is configured to implement some functionality, some component and/or components of the device, such as for example the at least one processor 202 and/or the at least one memory 204, may be configured to implement this functionality. Furthermore, when the at least one processor 202 is configured to implement some functionality, this functionality may be implemented using program code 206 comprised, for example, in the at least one memory 204.

The functionality described herein may be performed, at least in part, by one or more computer program product components such as software components. According to an embodiment, the device 200 comprises a processor or processor circuitry, such as for example a microcontroller configured by the program code 206, when executed, to execute the embodiments of the operations and functionality described herein. Alternatively, or in addition, the functionality described herein can be performed, at least in part, by one or more hardware logic components. For example, and without limitation, illustrative types of hardware logic components that can be used include FPGAs, ASICs, application-specific standard products (ASSPs), system-on-a-chips (SOCs), complex programmable logic devices (CPLDs), graphics processing units (GPUs), or the like.

The device 200 may be configured to perform method(s) described herein or comprise means for performing method(s) described herein. In one example, the means comprises the at least one processor 202, the at least one memory 204 including program code 206 configured to, when executed by the at least one processor 202, cause the device 200 to perform the method(s).

The device 200 may comprise, for example, a computing device such as for example a server, a mobile phone, a tablet, a laptop, an Internet-of-things device, a vehicle such as for example a car, a base station, or the like. Although the device 200 is illustrated as a single device, it is appreciated that, wherever applicable, functions of the device 200 may be distributed to a plurality of devices, for example, between components of a transmitter, a receiver, or a transceiver.

Referring back to FIG. 1, the HPLMN 130 may obtain configuration data associated with data traffic of the UE 110 for a given geographical area. The configuration data may comprise a mapping of the data traffic type to an identifier of the CPLMN 140, or in general identifiers of multiple CPLMNs configured to provide access to an appropriate edge application server, for example, EAS 1, at the same geographical area. The AF can identify or represent the target traffic by AF-Service-Identifier, which the NEF can map on to a combination of DNN and optionally S-NSSAI, and application identifier or traffic filtering information especially in the case of untrusted AF. The configuration data may be received from an application function (AF 2), for example, in an AF request. An application function may provide a representation of applications residing either inside or outside an operator's network that interact with the 5GC network. An application function may enable applications to interact with the 5GC and also influence some operations of the 5G core, for example, data traffic routing for an edge computing applications. An AF may interact with the 5GC, for example, using Nnef_ParameterProvision_Create or Nnef_ParameterProvision_Update operations or Nnef_TrafficInfluenceCreate/Update/Delete Request operations targeting an individual UE address. A trusted AF can directly interact with the PCF whereas untrusted AFs need to always interact through an NEF.

The AF request may be received at the HPLMN 130, for example, at H-NEF. An information element (IE) of the AF request may comprise an indication of potential locations of ASs per (C)PLMN granularity. The potential locations of application servers may indicate which (E)ASs are available in a given location, for example for handling a particular UE application. The UE application may be identified for example by an AF-Service-Identifier or one or many S-NSSAIs. The AF request may further indicate whether each (E)AS can be connected directly by a HPLMN or through a CPLMN. This may, for example, enable the HPLMN 130 to determine which PSA UPF to coordinate with, in order to route a given data traffic of a UE in case none of its own UPFs supports the required data network access identifier (DNAI) at a given geographical area and/or at a given time instance. The AF request may additionally include an indication of data network names (DNNs) supported by the CPLMN 140 and/or a fully qualified domain name (represented throughout the disclosure by the example of a fully qualified domain name (FQDN)) or an Internet Protocol (IP) address of EAS(s) accessible through the CPLMN 140. An FQDN may generally comprise data identifying a location of a network node within a Domain Name System (DNS).

An example of information included in an AF request is provided in Table 1. An AF request may comprise one or more of the disclosed information elements. The first column indicates the name of the information (element). The second and third columns indicate applicability of the information for the PCF and/or NEF. The fourth column may indicate an example of a category (mandatory/conditional/optional) for the information element. However, the use of the category may be optional and a different categorization may be alternatively applied. This applies also to other embodiments of the disclosure.

TABLE 1

| Information Name | Applicable for PCF or NEF | Applicable for NEF only | Category |
|---|---|---|---|
| Traffic | Defines the target traffic to be | The target traffic can be | Mandatory |
| Description | influenced, represented by the | represented by AF- | |
| | combination of DNN and | Service-Identifier, | |
| | optionally S-NSSAI, and | instead of combination | |
| | application identifier or traffic | of DNN and optionally | |
| | filtering information. | S-NSSAI. | |
| Potential | Indicates potential locations of | The potential locations | Conditional |
| Locations of | applications per PLMN-ID. | of applications can be | |
| Applications | | represented by AF- | |
| per (C)PLMN | | Service-Identifier per | |
| | | PLMN-ID | |
| PLMN-ID | If it is only available in a co- | | |
| | located PLMN, it is the PLMN-ID | | |
| | of a co-located PLMN. If, on the | | |
| | other hand, supported by HPLMN, | | |
| | it is the PLMN-ID of the HPLMN | | |
| Supported | Represented by a list of DNAI(s) | | |
| DNN/DNAI List | or DNN to be used. | | |
| N9 traffic | N9 traffic routing information | | |
| routing | corresponding to each DNAI | | |
| requirements | | | |
| FQDN or IP | This information per location can | | |
| address of EAS | be useful for HPLMN to identify | | |
| that are | appropriate local UPF to be used in | | |
| accessible | order to route traffic to CPLMN | | |
| through a given | | | |
| CPLMN | | | |
| Local routing | Indicates whether localized routing | | |
| required | is required | | |
| Target UE | Indicates the UE(s) that the request | GPSI can be applied to | Mandatory |
| Identifier(s) | is targeting, i.e. an individual UE, | identify the individual | |
| | a group of UE represented by | UE, or External Group | |
| | Internal Group Identifier, or any | Identifier can be applied | |
| | UE accessing the combination of | to identify a group of | |
| | DNN, S-NSSAI and DNAI(s). | UE | |
| Spatial Validity | Indicates that the request applies | The specified location | Optional |
| Condition | only to the traffic of UE(s) located | can be represented by a | |
| | in the specified location, | list of geographic zone | |
| | represented by areas of validity. | identifier(s). | |
| AF transaction | The AF transaction identifier refers | N/A | Mandatory |
| identifier | to the AF request. | | |
| N6 Traffic | Routing profile ID and/or N6 | N/A | Optional |
| Routing | traffic routing information | | |
| requirements | corresponding to each DNAI and | | |
| | an optional indication of traffic | | |
| | correlation. | | |
| Application | Indicates whether an application | N/A | Optional |
| Relocation | can be relocated once a location of | | |
| Possibility | the application is selected by the | | |
| | 5GC. | | |
| UE IP address | Indicates UE IP address should be | N/A | Optional |
| preservation | preserved. | | |
| indication | | | |
| Temporal Validity | Time interval(s) or duration(s). | N/A | Optional |
| Condition | | | |
| Information on AF | Indicates whether the AF | N/A | Optional |
| subscription to | subscribes to change of UP path of | | |
| corresponding | the PDU Session and the | | |
| SMF events | parameters of this subscription. | | |

AF requests may be used, for example, for traffic steering (after a PCF has created appropriate PCC rules), 5GC-based event subscription (e.g., UP) path management event), and/or 5G local area network (5GLAN) purposes. However, as indicated the above table, an AF request may comprise information for the purpose of ensuring required traffic steering behaviour between the HPLMN 130 and a CPLMN 140.

AF-based traffic steering may be applied to non-roaming and LBO cases, where the involved entities (e.g. AF, PCF, SMF, and/or UPF) may belong to a serving PLMN or where the AF belongs to a third party with which the serving PLMN has an agreement. Embodiments of the present disclosure may address involvement of network functions belonging to two or more PLMNs. For example, the HPLMN 130 may be informed about application location per CPLMN granularity and per geographic location, for example, a tracking area (TA). This enables an AM/F associated with the HPLMN 130 to determine that it needs to involve an SMVF belonging to a CPLMN for the purpose of selecting appropriate PSA or intermediate (I) UPF(s) belonging to the CPLMN 140 and to allow routing user traffic to a local access to a data network (identified by a DNAI) which is accessible through the PSA UPF belonging to CPLMN 140.

As described in the above table, the AF request may comprise an indication of potential locations of application(s) for one or more PLMNs, for example, the CPLMN 140. The AF Request may additionally include FQDN or IP address of EAS that are accessible through a given CPLMN, at least one of a supported DNN or DNAI list per CPLMN, and N9 traffic routing requirement(s) per S-NSSAI or DNAI per CPLMN.

An AF request transmitted by an application function to the HPLMN 130 may therefore include one or more of the following information elements. The information elements may be associated with a given type of data traffic or AF-Service-Identifier, which may be associated with a given geographical area (e.g. TA):
Application location(s). For example, at least one supported DNAI and/or DNN per CPLMN. This can be in the form of AF-Service-Identifier that can be mapped on to appropriate DNAI by an NEF when it is involved.
N9 traffic routing information (e.g., GTP-U N9 tunnel) between UPFs of the HPLMN 130 and at least one CPLMN. This information may be provided for each DNAI. This information may include, for one or more S-NSSAIs, corresponding DNN(s) to be used in a given CPLMN for a given geographical area.
A DNN associated with LADN and spatial validity to use a particular LADN.
Application or Service identifier. AF-Service-Identifier or DNN to be used in a given geographical area per CPLMN-ID. The DNN may be associated with a local area network of an CPLMN and it may be provided with spatial validity. AF-Service-Identifier may be translated, for example, by an NEF, into S-NSSAI, DNN, that are supported by an HPLMN and, if possible, mapping S-NSSAI information that is relevant for the CPLMN that is to be used in a given geographical area (e.g. TA).
FQDN or IP address(es) of EAS(s) that are accessible through a given CPLMN.
S-NSSAI mapping between HPLMN and CPLMN, if possible.
A requirement for mandating localised routing of the data traffic, e.g. through a shortest path, to an appropriate EAS as opposed to a remote application server.

Based on the configuration data, the HPLMN 130 may cause routing of the data traffic to a suitable CPLMN. The routing may comprise, for example, generating corresponding PCC rules by the PCF of the HPLMN (H-PCF) and providing corresponding access and mobility related policy control data to an AMF of the HPLMN 130 (H-AMF), as will be further described below.

In case of roaming, a VPLMN may identify a HPLMN of a UE using the SUPI, which may contain the HPLMN-ID. In the embodiments of the present disclosure, an CPLMN-ID may be explicitly provided to the HPLMN, for example, by an AF or by a static configuration, such that the H-PCF may include that information as part of a PCC rule that is passed on to an SMF of the HPLMN (H-SMF) handling the data traffic, for example, data traffic of a particular type. The CPLMN related information of the AF request may enable the H-SMF to identify a local UPF of the HPLMN 130 (H-UPF), which may be selected to be used for connecting to an CPLMN for the given traffic type or data traffic associated with a particular value of S-NSSAI. An AF may indicate spatial relevance, for example, by using a list of geographic zone identifier(s). Relevant PCC rules may be created by the H-PCF. IP address may be used to evaluate proximity of an H-UPF to a UPF of an CPLMN (C-UPF).

If an AF belonging to an RTA cannot contact the HPLMN 130, the necessary PCC rules may be retrieved from a PCF of the CPLMN 140 (C-PCF). An C-PCF may therefore contact a relevant H-PCF for a given data traffic in a given geographical location. If this is not possible, the C-PCF may contact the 5GC of the HPLMN 130 in the capacity of an AF. The AF requests that target existing or future PDU sessions of UE(s) may be sent through the NEF and they may target one or more PCFs. The PCF(s) may transform the AF requests into policies that apply to PDU sessions. The data traffic may be identified in the AF request, for example, by a DNN and, optionally, network slicing information (e.g. S-NSSAI) or an AF-Service-Identifier. Inter-PLMN UP Security (IPUPS) functionality may be deployed by operators at each local border of their networks to protect their networks from invalid inter-PLMN N9 traffic.

The CPLMN related information of the AF request, or otherwise configured at the HPLMN 130, may be reflected in corresponding dynamic PCC rule creation. This may be done to enable the H-SMF to identify and make use of an C-UPF that is located in the CPLMN 140 with help of an C-SMF. Based on this information, the H SMF may decide which H-UPF to choose for routing the identified data traffic to an appropriate I/PSA-UPF that is located in the CPLMN 140. In an example, embodiment, the SMF may be configured to select, at least based on PCC rules, S-NSSAI and DNN, an UPF of the HPLMN 130 for routing the data traffic to the CPLMN 140. This may be done based on the configuration data received in the AF request or preconfigured at the HPLMN 130.

The H-PCF may further determine, based on the configuration data, PCC rules for the H-SMF for selecting an C-UPF for routing the data traffic to the edge application server. The C-UPF may be chosen and managed by an appropriate C-SMF. The determined PCC rules may be provided to the H-SMF. An example of PCC rule information is included in the Table 2. The PCC rule information may comprise one or more of the information elements of Table 2. The PCC rules may be provided as AF influenced traffic steering enforcement control information. The first column indicates the name of the information (element), the second column provides a description, and the third column indicates whether a PCF may be permitted to modify the information.

TABLE 2

| | | PCF permitted to |
|---|---|---|
| | | modify for a dynamic |
| Information name | Description | PCC rule in the SMF |
| AF influenced Traffic | This part describes information required for | |
| Steering Enforcement | AF influenced Traffic Steering. | |
| Control | | |
| Data Network Access | Identifier(s) of the target DNAI. | Yes |
| Identifier | | |
| Per DNAI: Traffic | Reference to a pre-configured traffic steering | Yes |
| steering policy | policy at the SMF. | |
| identifier | | |
| Per DNAI: | Describes the information necessary for | Yes |
| N6 traffic routing | traffic steering to the DNAI. | |
| information | | |
| Per DNAI: | PSA UPF can be located in a Co-located | Yes |
| PLMN-ID of CPLMN | PLMN and hence, PLMN-ID of Co-located | |
| where it is available | PLMN may be indicated | |
| Per DNAI: FQDN or | This information per location can be useful | Yes |
| IP address of EAS that | for HPLMN to identify appropriate local | |
| are accessible through | UPF to be used in order to route traffic to | |
| a given CPLMN | CPLMN | |
| Information on AF | Indicates whether notifications in the case of | Yes |
| subscription to UP | change of UP path are requested and | |
| change events | optionally indicates whether | |
| | acknowledgment to the notifications shall be | |
| | expected. | |
| Indication of UE IP | Indicates UE IP address should be preserved. | Yes |
| address preservation | | |
| Indication of traffic | Indicates that the target PDU Sessions should | Yes |
| correlation | be correlated via a common DNAI in the user | |
| | plane. | |

As indicated in Table 2, the PCC rule information may comprise DNAI information per CPLMN granularity. The PCC rule information may indicate what DNAI is available in which (C)PLMN. The PCC rules may therefore comprise a mapping between at least one supported DNAI and the identifier of the CPLMN 140. If the PCC rule additionally contains a requirement to use local edge resources for routing identified data traffic, the H-SMF may determine as to which local H-UPF to select to route a traffic to a data network (identified by a DNAI), which is accessible through the CPLMN 140. To enable this, local UPFs may connect across PLMN borders without having to use any centralized remote UPF.

The HPLMN 130 may further configure access and mobility related policy information to enable quick selection of the C-SMF for the data traffic to be routed. This may be achieved by indicating which CPLMN(s) are allowed for a given UE per tracking area identifier (TAI). H-PCF prepares and such access and mobility information may be provided to the H-AMF. This enables the H-AMF to determine which CPLMN(s) a UE is allowed to access to route given type of data traffic. The access and mobility related policy information may indicate a list of CPLMNs that are allowed to be accessed per geographical locations identified, for example, by a T, for a given UE to route a given traffic type. Table 3 provides an example of access and mobility related policy control information. Access and mobility related policy control information may comprise one or more of the information elements of Table 3. The first column indicates the name of the information element and the second column provides a description for the information element. The third and fourth columns may indicate a category and scope for the information element, respectively.

TABLE 3

| Information name | Description | Category | Scope |
|---|---|---|---|
| UE-AMBR | This defines the UE aggregate | Conditional | UE context |
| | maximum bit rate (UE-AMBR) value | | |
| | that applies for a UE | | |
| Service Area | This part defines the service area | | |
| Restrictions | restrictions | | |
| List of allowed TAIs. | List of allowed TAIs | Conditional | UE context |
| List of non-allowed | List of non-allowed TAIs | Conditional | UE context |
| TAIs. | | | |
| Maximum number of | The maximum number of allowed | Conditional | UE context |
| allowed TAIs | TAIs. | | |
| RFSP Index | This part defines the RFSP (radio | | |
| | access technology/frequency | | |
| | selection priority) index | | |
| RFSP Index | Defines the RFSP Index that applies | Conditional | UE context |
| | for a UE | | |
| Home SMF Selection | This part defines the SMF selection | | |
| Management | management instructions | | |
| DNN replacement of | Defines if a UE requested unsupported | Conditional | UE context |
| unsupported DNNs | DNN is requested for replacement by | | |
| | PCF | | |
| List of S-NSSAIs | Defines the list of S-NSSAIs | Conditional | UE context |
| | containing DNN candidates for | | |
| | replacement by PCF | | |
| Per S-NSSAI: List of | Defines UE requested DNN candidates | Conditional | UE context |
| DNNs | for replacement by PCF | | |
| Co-located SMF | | | |
| Selection Management | | | |
| Allowed Co-located | PLMN-ID list of Allowed Co-located | Conditional | UE context |
| PLMN per TAI | PLMN that can take UE traffic to PSA | | |
| | UPF | | |
| Per CPLMN-ID: | Supported List of S-NSSAI of a Co- | Conditional | UE context |
| Supported List of S- | located PLMN | | |
| NSSAIs mapping per | | | |
| TAI | | | |
| Per CPLMN-ID: | Supported List of DNN of a Co-located | Conditional | UE context |
| Supported List of | PLMN | | |
| DNN/DNAI | | | |

The access and mobility related policy information additionally contain information that is useful for an H-AMF to choose the appropriate C-SMF to handle a particular traffic type identified at least by S-NSSAI, DNN, DNAI. This additional information may be identified by Co-located SMF Selection Management in Table 3 and three different pieces of information it contains such as Allowed Co-located PLMN per TAI for a given UE, Supported List of S-NSSAIs mapping per TAI per CPLMN and Supported List of DNN/DNAI per CPLMN.

According to an embodiment, the URSP information may include CPLMN related information. URSP helps a UE include appropriate S-NSSAI and/or DNN information at the time of the PDU session establishment. This information enables a gNB to select the appropriate AMF, which in turn may select appropriate SMFs to handle a given PDU session. This information may be further used for UPF/PCF selection. URSP configuration may therefore play a role in the 5GS for routing given UE data traffic while enlisting appropriate NFs. Unless statically configured, URSP may enable the 5GS to choose appropriate NFs to handle a given data traffic type generated by a particular UE. The PCF attached to HPLMN 130 may provision the UE 110 with network slice selection policy (NSSP) information as part of the URSP rules. This enables a UE to indicate the need for external CPLMN traffic steering or routing.

Since the HPLMN 130 may utilize a CPLMN to route given data traffic generated by the UE, control functions associated with the HPLMN 130 may determine which CPLMN to choose in a given geographical area (e.g. TA) to route the particular UE traffic. Accordingly, the URSP may be configured such that a traffic descriptor of the URSP includes an indication of a need for external CPLMN routing. For example, the traffic descriptor may be provided with an indication that data traffic of a given type is to be routed through a CPLMN. The HPLMN 130 may, for example, determine to choose the CPLMN 140. Furthermore, a route selection descriptor may indicate which a set of S-NSSAI/DNN is to be included corresponding to HPLMN and CPLMN respectively by the UE 110 at the time of PDU session establishment. An example of a traffic descriptor part of URSP information is provided in Table 4. URSP information (or rule) may comprise one or more of the information elements of Table 4. The first and second columns indicate a name and description of the information element. The third to fifth columns indicate a category of the information element, a permission for PCF to modify the information element, and a scope of the information element, respectively.

TABLE 4

| | | | PCF permitted | |
|---|---|---|---|---|
| Information | | | to modify in a | |
| name | Description | Category | UE context | Scope |
| Rule | Determines the order the URSP | Mandatory | Yes | UE context |
| Precedence | rule is enforced in the UE. | | | |
| Traffic | This part defines the Traffic | Mandatory | | |
| descriptor | descriptor components for the | | | |
| | URSP rule. | | | |
| Application | It consists of OSId and | Optional | Yes | UE context |
| descriptors | OSAppId(s). | | | |
| Need for | Tells a network to seek assistance | Optional | Yes | UE context |
| external | of an CPLMN-ID | | | |
| CPLMN | | | | |
| Routing | | | | |
| IP | Destination IP 3 tuple(s) (IP | Optional | Yes | UE context |
| descriptors | address or IPv6 network prefix, | | | |
| | port number, protocol ID of the | | | |
| | protocol above IP). | | | |
| Domain | Destination FQDN(s) or a regular | Optional | Yes | UE context |
| descriptors | expression as a domain name | | | |
| | matching criteria. | | | |
| Non-IP | Descriptor(s) for destination | Optional | Yes | UE context |
| descriptors | information of non-IP traffic | | | |
| DNN | This is matched against the DNN | Optional | Yes | UE context |
| | information provided by the | | | |
| | application. | | | |
| Connection | This is matched against the | Optional | Yes | UE context |
| Capabilities | information provided by a UE | | | |
| | application when it requests a | | | |
| | network connection with certain | | | |
| | capabilities. | | | |
| List of Route | A list of Route Selection | Mandatory | | |
| Selection | Descriptors. Example provided in | | | |
| Descriptors | Table 5. | | | |

The URSP information may be determined by the HPLMN 130, for example, by the H-PCF. As provided in Table 4, the URSP information may comprise a request for external routing of the data traffic through an CPLMN, which may be identified in the URSP by an (C)PLMN-ID.

The list of route selection descriptors of the URSP may comprise one or more route selection descriptors (RDS). An RDS part of the URSP may comprise a list of S-NSSAI(s) and/or DNN(s) to be used in the HPLMN 130 and the CPLMN 140, respectively. This enables a UE to include two sets of S-NSSAI/DNN pairs corresponding to the HPLMN 130 and the CPLMN 140, respectively, at the time of a PDU session establishment. An example of information elements of RSD is provided in Table 5. The RSD may comprise one or more of the information elements of Table 5. The columns provide information similar to Table 4. Even though in this example, the RDS is part of the URSP, it is appreciated that similar information may be provided within any suitable signalling information.

TABLE 5

| Information | | | PCF permitted to | |
|---|---|---|---|---|
| name | Description | Category | modify in URSP | Scope |
| Route | Determines the order in | Mandatory | Yes | UE context |
| Selection | which the Route Selection | | | |
| Descriptor | Descriptors are to be applied. | | | |
| Precedence | | | | |
| Route | This part defines the route | Mandatory | | |
| selection | selection components | | | |
| components | | | | |
| SSC Mode | One single value of session | Optional | Yes | UE context |
| Selection | and service continuity (SSC) | | | |
| | mode. | | | |
| Home PLMN | | | | |
| Network | Either a single value or a list | Optional | Yes | UE context |
| Slice | of values of S-NSSAI(s) | | | |
| Selection | | | | |
| DNN | Either a single value or a list | Optional | Yes | UE context |
| Selection | of values of DNN(s). | | | |
| Co-located | | | | |
| PLMN-ID | | | | |
| per TA/RA | | | | |
| Network | Either a single value or a list | Optional | Yes | UE context |
| Slice | of values of S-NSSAI(s) | | | |
| Selection | | | | |
| DNN | Either a single value or a list | Optional | Yes | UE context |
| Selection | of values of DNN(s). | | | |
| PDU Session | One single value of PDU | Optional | Yes | UE context |
| Type | Session Type | | | |
| Selection | | | | |
| Non- | Indicates if the traffic of the | Optional | Yes | UE context |
| Seamless | matching application is to be | | | |
| Offload | offloaded to non-3GPP | | | |
| indication | access outside of a PDU | | | |
| | Session. | | | |
| Access Type | Indicates the preferred | Optional | Yes | UE context |
| preference | Access Type (3GPP or non- | | | |
| | 3GPP or Multi-Access) when | | | |
| | the UE establishes a PDU | | | |
| | Session for the matching | | | |
| | application. | | | |
| Route | This part defines the Route | Optional | | |
| Selection | Validation Criteria | | | |
| Validation | components | | | |
| Criteria | | | | |
| Time | The time window when the | Optional | Yes | UE context |
| Window | matching traffic is allowed. | | | |
| | The RSD is not considered to | | | |
| | be valid if the current time is | | | |
| | not in the time window. | | | |
| Location | The UE location where the | Optional | Yes | UE context |
| Criteria | matching traffic is allowed. | | | |
| | The RSD rule is not | | | |
| | considered to be valid if the | | | |
| | UE location does not match | | | |
| | the location criteria. | | | |

The list of RDSs may be generated by the H-PCF and provided to the UE 110, for example, within the URSP. An RDS may comprise S-NSSAI(s) and/or DNN(s) of the HPLMN 130. The RDS may further comprise a mapping between geographical area(s) (e.g. TAI(s) or RAIL(s)) and supported S-NSSAI(s) or DNN(s) of the CPLMN(s), for example, CPLMN 140. Hence, a mapping between S-NSSAI information between the HPLMN 130 and the CPLMN 140 may be provided. The HPLMN 130 may cause the URSP to be transmitted to the UE 110, for example, by providing the URSP to the gNB 2 for transmission.

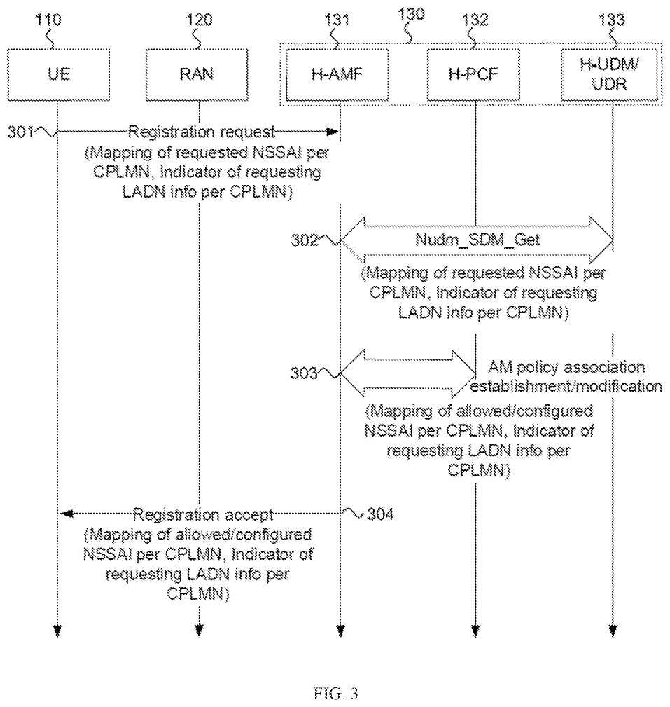

FIG. 3 illustrates an example of a user equipment registration procedure, according to an embodiment of the present disclosure. The UE registration procedure may involve the UE 110 and the core network elements H-AMF 131, H-PCF 132, and H-UDM/UDR 133. The UE 110 may access the core network of the HPLMN 130 via a radio access network 120, for example, a gNB. Similar procedure may be performed for multiple UEs.

In case of roaming, the UE 110 may include a mapping of S-NSSAI that it uses in HPLMN for a VPLMN to find the appropriate S-NSSAI to be used. The AMF may update the UE 110 with a configured NSSAI for the serving PLMN and/or allowed NSSAI and/or the associated mapping to HPLMN S-NSSAIs. However, since the CPLMN 140 may be used without roaming, the UE 110 may provide a list of S-NSSAI mapping to be used in the CPLMN 140 along with corresponding DNN. This may include a mapping of requested NSSAI (if available), which may comprise mapping of each S-NSSAI of the requested NSSAI, to the CPLMN S NSSAIs. For each access type level context within the UE access and mobility context of UE context in AMF, the following may be additionally included: mapping of allowed NSSAI per CPLMN-ID.

A requested NSSAI may comprise S-NSSAI(s) requested by UE 110 for the data traffic. A configured NSSAI may be configured for a UE by the relevant PLMN and it may apply to the relevant PLMN, e.g. the HPLMN 130 or the CPLMN 140. The configured NSSAI may comprise standard S-NSSAI values or values specific to the relevant PLMN. An allowed NSSAI may comprise a value assigned by the relevant PLMN, which may be allowed within a geographical area, for example, a registration area or the entire HPLMN. The requested NSSAI may be a configured NSSAI or an allowed NSSAI.

At operation 301, the UE 110 may transmit a registration request. The registration request may comprise mapping of requested NSSAI per CPLMN. This may include a mapping between S-NSSAI(s) of the requested NSSAI of the HPLMN 130 and S-NSSAI(s) of the CPLMN 140. The UE 110 may further transmit an indicator of requesting LADN information per CPLMN. The UE 110 may transmit the registration request to the H-AMF 131. The transmission may be via the radio access network 120. The H-AMF 131 may receive the registration request.

At operations 302 and 303, the H-AMF 131 may retrieve, from the H-UDM/UDR 133, a mapping of allowed or configured NSSAIs between the HPLMN 130 and the CPLMN(s). The H-AMF 131 may further retrieve the LADN information for the CPLMN(s) and/or a list of CPLMNs per geographical area. Retrieving the information may, for example, comprise providing a Nudm_SDM_Get request to the H-UDM/UDR 133. The Nudm_SDM_Get request may comprise a mapping of the requested NSSAI per CPLMN and/or the indicator of requesting the LADN information per CPLMN. The request to the H-UDM/UDR 133 may therefore comprise the information received from the UE 110 in the registration request. The H-UDM/UDR 133 may receive the request from the H AMF 131, and in response, provide the H-AMF 131 with the mapping of the allowed or configured NSSAI per CPLMN and/or the LADN information. This information may be provided to the H-AMF 131, for example, in an access and mobility (AM) policy association establishment or modification message. Retrieving the data form the H-UDM/UDR 133 may be in response to determining that the H AMF 131 does not have subscription data for the UE 110. In general, the retrieved data may comprise access and mobility subscription data, SMF selection subscription data, UE context in SMF data, and/or location service (LCS) mobile origination. Retrieving the data may be performed via H-PCF 132. For example, the H-AMF 131 may provide to the H-PCF 132 the relevant information, for example, the allowed NSSAI and, if available, the mapping of allowed NSSAI.

At operation 304, the H-AMF 131 may cause transmission of a registration accept message to the UE 110, for example, by providing the registration accept message to the radio access network 120 for transmission to the UE 110. The registration accept message may comprise the mapping of allowed or configured NSSAI(s) between the HPLMN 130 and the CPLMN 140. The registration accept message may further comprise the LADN information for the CPLMN 140 and/or the list of CPLMN(s) per geographical area. The UE 110 may receive the registration accept message. The UE 110 may use the information of the registration accept message, for example, when establishing a PDU Session to make a connection with an EAS of the CPLMN 140 via the HPLMN 130. The information may be, for example, included in a PDU session establishment request, as will be further described below.

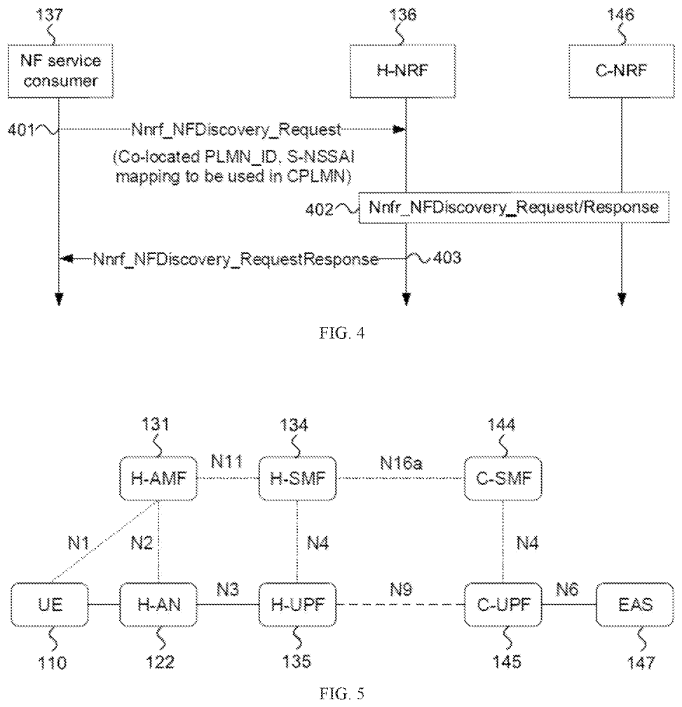

FIG. 4 illustrates an example of an NF service discovery procedure across two public land mobile networks, according to an embodiment of the present disclosure. The NF/NF service discovery procedure (Nnrf_NFDiscovery) may be part of a PDU session establishment procedure. As described above, the UE 110 may transmit to the core network of the HPLMN 130 as part of PDU Session Establishment procedure, an indication of external CPLMN routing requirement, S-NSSAI/DNN to be used in the HPLMN 130 and S-NSSAI/DNN to be used in the CPLMN 140. This may be based on the URSP configuration, as explained above, or a static configuration on the UE 110 and/or the H PCF 132. The inclusion of the CPLMN-ID in the PDU session establishment procedure may enable the H-AMF 131 to enquire correct NRF for the purpose of identifying and subsequently using appropriate C-SMF belonging to the CPLMN 140. In other words, the inclusion of CPLMN-ID may impact the way the NF/NF service discovery procedure takes place.

At operation 401, an NF service consumer 137, for example, the H-AMF 131, may transmit an NF discovery request to the NRF of the HPLMN 130 (H-NRF 136). This request may comprise the CPLMN-ID and S-NSSAI(s) to be used in the CPLMN 140. The H-NRF 136 may receive the NF service discovery request and identify the NRF of the CPLMN (C-NRF 146) based on the CPLMN-ID.

At operation 402, the H-NRF 136 may transmit an NF discovery request to the C-NRF 146 to request NF discovery service from the CPLMN 140 and to obtain NF profile(s) of the NF instance(s) deployed in the CPLMN 140. The H-NRF 136 may receive, from the C-NRF 146, an NF service discovery response, which may, for example, comprise an identifier of an SMF of the CPLMN 140 (C-SMF) to be used for routing the data traffic of the UE 110.

FIG. 5 illustrates an example of network functions of a home public land mobile network and a co-located public land mobile network, according to an embodiment of the present disclosure. FIG. 5 illustrates network functions, which may be involved in the routing of a given UE data traffic to the CPLMN 140. The UE 110 may be served by an access node 122 of the HPLMN 130 (H-AN), for example, a gNB. The UE 110 may communicate with the H-AMF 131 over a communication interface such as, for example, an N1 interface, which may be physically routed via the H-AN 122. The H AN 122 may communicate with the H-AMF 131 over a communication interface such as, for example, an N2 interface. The H-AN 122 may further communicate with H-UPF(s) 135 over a communication interface such as, for example, an N3 interface. The H-SMF 134 may communicate with the H-UPF(s) 135 over a communication interface such as, for example, an N4 interface.

The H-AN 122 may be configured to choose an appropriate H-AMF 131 based on requested NSSAI, a 5G globally unique temporary identifier (5G-GUTI), a 5G serving temporary mobile subscriber identity (5G-TMSI), and/or a globally unique AFN identifier (GUAMI). Once the H-AMF 131 has been chosen, appropriate H-SMF 134 and C-SMF 144 may be chosen based on the CPLMN related information described above, for example, the CPLMN-ID to be used and sets of S-NSSAI/DNN to be used in the HPLMN 130 and CPLMN 140, respectively. This information may be included, for example, in a non-access stratum (NAS) service request or PDU session establishment request. SMF selection functionality of the HPLMN 130 may select the H-SMF 134 based on the S-NSSAI of the HPLMN 130 and the C-SMF 144 based on the S NSSAI of the CPLMN 140. The H-AMF 131 may select the H SMF 134 and/or the C-SMF 144 directly, or indirectly through a service communication proxy (SCP) or NRF in case delegated discovery is used, for example, based on an SMF service area, an extra UE indication, and/or UE location.

The H-AMF 131 may communicate with the H-SFM 134 over a communication interface such as for example an N11 interface. The H-SMF 134 may communicate with the C-SMF 144 over a communication interface such as for example an N16a interface. When the C-SMF 144 is inserted into a PDU session, for example, during PDU session establishment, the C-SMF 144 may provide the DNAI list or AF-Service-Identifier list it supports to the H-SMF 134. Based on the DNAI list information received from the C-SMF 144, the H-SMF 134 may provide the DNAI(s) or AF-Service-Identifier list of interest for the PDU session for local traffic steering to the C-SMF 144. The C-SMF 144 may be responsible of the insertion, modification, and/or removal of C-UPF(s) 145 to ensure local traffic steering. The H-SMF 134 may not need to have access to local configuration or NRF output related with the C-UPF(s) 145 controlled by the C-SMF 144. The H-SMF 134 may provide N4 information to the C-SMF 144, the N4 information indicating how the data traffic is configured to be detected, enforced, and/or monitored in the C-UPF(s) 145 controlled by the C-SMF 144. The H-SMF 134 may, for example, issue request(s) to the C-SMF 144, the request(s) comprising N4 information to be used for creating/updating/removing packet detection rule(s) (PDR), forwarding action rule(s) (FAR), quality-of-service (QoS) enforcement rule(s) (QER), and/or usage reporting rule(s) (URR). The H-SMF 134 may generate information for local traffic offload based on the available DNAI(s) indicated by the C-SMF 144, PCC rules associated with these DNAI(s), and/or charging requirement(s). This (N4) information may be provided by the H-SMF 134 to the C-SMF 144 over the N16a interface. The C-SMF 144 may use this information to derive appropriate rules for the C-UPF(s) 145 controlled by the C-SMF 144, for example, via the N4 interface. The C-UPF(s) 145 may route the data traffic to the EAS 147, for example, over the N6 interface. The data traffic may be received from the H-UPF(s) 135, for example, via the N9 interface.

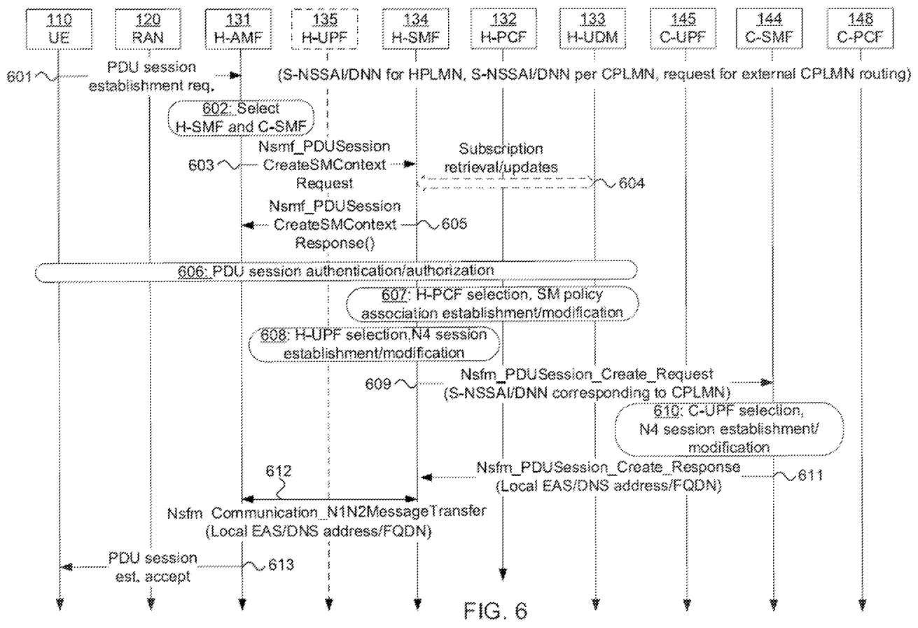

FIG. 6 illustrates an example of a packet data unit session establishment procedure, according to an embodiment of the present disclosure. The illustrated PDU session establishment procedure may involve NFs from both the HPLMN 130 and the CPLMN 140, while considering UE 110 provided additional S-NSSAI and DNN mapping information and/or the explicit indication to apply external routing using the CPLMN 140. This information may enable the H-AMF 131 to choose appropriate H-SMF 134 and C-SMF 144 during the PDU session establishment. Unlike in the case of home routed roaming, the H-PCF 132 may be involved in a session management (SM) policy association establishment procedure to establish an SM policy association with the PCF and to obtain default PCC rules for the PDU session. The C-PCF 148 may be used by the C-SMF 144 to choose appropriate C-UPF(s) 145 to route UE data traffic to the data network identified by a DNAI. The disclosed PDU session establishment procedure may be used to pass FQDN or IP address of a DNS or an EAS on to the UE 110 as part of PDU session establishment accept message. For example, a protocol configuration option (PCO) may be configured for this purpose. UPF provisioning may include an indication of neighbour UPF(s) and their respective UPFInfo list(s). Furthermore, the NEF may provide a list of DNAI(s) supported by UPF(s), for example, over an N27 interface. Even though the embodiments of FIG. 6 have been illustrated in the context of PDU session establishment, it may be generally used to establish any suitable communication sessions.

At operation 601, the UE 110 may transmit a PDU session establishment request. The PDU session establishment request may comprise S-NSSAI(s) and/or DNN(s) to be used in the HPLMN 130 mainly for the purpose of finding appropriate NFs of the HPLMN to handle a given UE traffic type. The PDU session establishment request may further comprise S-NSSAI(s) and/or DNN(s) mainly for the purpose of finding appropriate NFs of the CPLMN 140 to handle a given UE traffic type. The PDU session establishment request may further comprise a request for external routing through the CPLMN 140. The PDU session establishment request may be transmitted to the H-AMF 131, for example, over the N2 interface via a base station of the RAN 120. The H-AMF 131 may receive the PDU session establishment request. The extra S-NSSAI and DNN mapping to be used in the HPLMN 130 and the CPLMN 140, respectively, and/or an explicit indication to apply external routing through the CPLMN 140 may cause an H-AMF to choose the C-SMF 144 and H-SMF 134 to handle data traffic associated with a given PDU Session. A PDU session may be established. The establishment of the PDU session may comprise one or more of operations 603 to 612.

At operation 602, the H-AMF 131 may select the H-SMF 134 and the C-SMF 144 based on the PDU session establishment request. The H-SMF 134 and the C-SMF 144 may be selected based on the S-NSSAI(s) and/or DNN(s) of the HPLMN 130 and the CPLMN 140 indicated in the PDU session establishment request, for example, in response to receiving the request for the external routing. The H-AMF 131 may, for example, select the H-SMF 134 that is associated with the indicated S-NSSAI(s) and/or DNN(s) of the HPLMN 130. The H-AMF 131 may further select C-SMF 144 that is associated with the indicated S-NSSAI(s) and/or DNN(s) of the CPLMN 140. This may be enabled by the mapping of the S-NSSAI(s) and/or DNN(s) of the HPLMN 130 and the CPLMN 140 in the PDU session establishment request.

At operation 603, the H-AMF 603 may provide a PDU session create SM context request (e.g. Nsmf_PDUSession_CreateSMContext Request) to the selected H-SMF 134. The H-AMF 131 may cause establishment of the PDU session by sending the PDU session create request to the H-SMF 134.

At operation 604, the H-SMF 134 may perform subscription retrieval/update to obtain (up-to-date) subscription information of the UE 110 from the H-UDM 133.

At operation 605, the H-AMF 131 may receive a PDU session create SM context response (e.g. Nsmf_PDUSession_CreateSMContext Response) from the H-SMF 134.

At operation 606, a PDU session authentication or authorization may be performed. This operation may be performed by the H-SMF 134 by consulting the H-UDM 133, using information about the UE 110, provided, for example, in the PDU session establishment request.

At operation 607, the H-SMF 134 may select the H-PCF 132. Session management policy association establishment or modification may be then performed among the H-SMF 134, H-PCF 132, and/or H-UDM 133.

At operation 608, the H-SMF 134 may perform selection of the H-UPF 135. An N4 session between the H-SMF 134 and the H-UPF 135 may be established or modified. This may involve the H-SMF 134, the H-UPF 135, and/or the H-PCF 132.

At operation 609, the H-SMF 134 may transmit a PDU session create request (e.g. Nsfm_PDUSession_Create_Request) to the C-SMF 144. The PDU session create request may comprise the S-NSSAI(s) and/or DNN(s) of the CPLMN 140, which may be received from the H-AMF 131.

At operation 610, the C-SMF 144 may perform selection of the C-UPF 145. An N4 session between the C-SMF 144 and the C-UPF 145 may be established or modified.

At operation 611, the C-SMF 144 may transmit a PDU session create request response (e.g. Nsfm_PDUSession_Create_Response) to the H-SMF 134. The PDU session create request response may comprise the IP address of the EAS and/or the FQDN of the EAS. The PDU session create request response may further comprise the IP address of a DNS server and/or an FQDN of the DNS server. Hence, a local EAS/DNS address(es) at the CPLMN 140 may be provided to the H-SMF 134.

At operation 612, the H-SMF 134 and the H-AMF 131 may perform N1N2 message transfer (e.g. Nsfm_Communication_N1N2MessageTransfer). For example, the H-SMF 134 may provide to the H-AMF 131 the local EAS/DNS address(es), for example, as the IP address or FQDN of the EAS and/or the IP address or FQDN of the DNS server.

At operation 613, the H-AMF 131 may cause transmission of a PDU session establishment accept message to the UE 110, for example, via a base station of the RAN 120. The PDU session establishment accept message may comprise the IP address or FQDN of the EAS. PDU session establishment accept message may further comprise the IP address or FQDN of the DNS server. The UE 110 may receive the PDU session establishment accept message. The UE 110 may then communicate data traffic with the indicated EAS using the established PDU session. The UE 110 may communicate the data traffic with the EAS using the RAN 120 of the HPLMN 130. Hence, a connection with the CPLMN 140 may be maintained through a base station of the HPLMN 130.

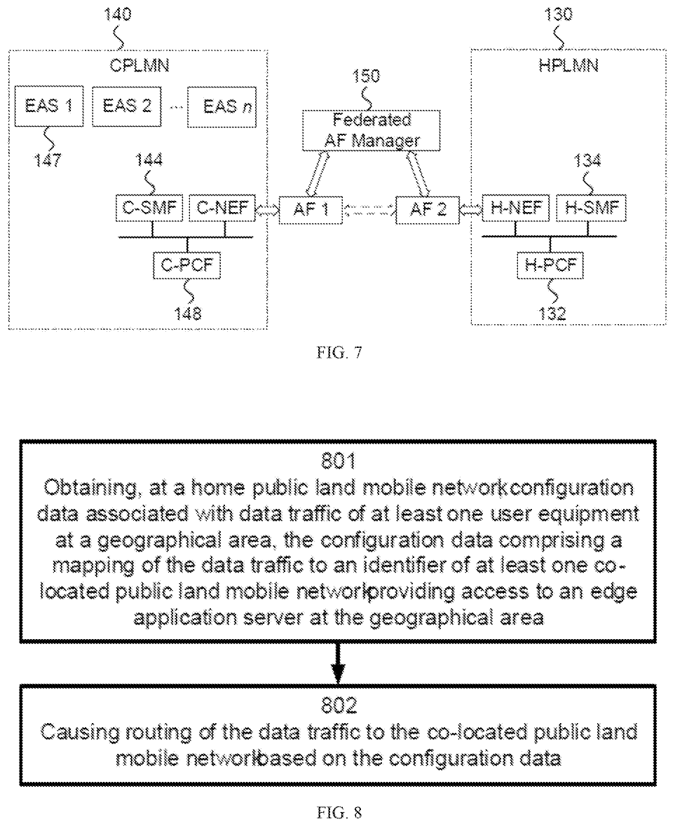

FIG. 7 illustrates an example of two public land mobile networks and a federated application function manager, according to an embodiment of the present disclosure. The HPLMN 130 and the CPLMN 140 may comprise various network functions as described with reference to FIG. 1. The CPLMN 140 may comprise one or a plurality of edge application servers (EAS 1 to EAS n). The federated AF manager 150 may obtain CPLMN-specific data traffic routing information from the AF 1 and pass it on to AF 2 to enable AF 2 to interact with the HPLMN 130. The data traffic routing information may comprise N9 routing information, e.g. routing information of the interface between UPFs of the HPLMN 130 and the CPLMN. The N9 routing information may be associated with a geographical area, for example, a tracking area. The data traffic routing information may further comprise a list of supported AF-Service-Identifiers or DNAI(s) of the CPLMN 140 at a given geographical area. The data traffic routing information may further comprise a list of supported S-NSSAI(s) and/or DNN(s) at the geographical area by the CPLMN. The list of supported S-NSSAI(s) and/or DNN(s) may be associated with one or a plurality of application function service identifiers. The data traffic routing information may further comprise mapping information between non-standardized S-NSSAI(s) of the HPLMN 130 and CPLMN 140. The federated AF manager 150 may be configured to provide the data traffic routing information received from the AF 1 to the AF 2. This information may be provided to a UE 110 of the HPLMN in the form of a URSP configuration, in order to establish a PDU session to communicate with one of the EASs of the CPLMN via the HPLMN 130, as described above. The AF 1 may interact with the AF 2 directly, if there is a direct communication channel is available between the AFs. If not, the federated AF manager, which may be centrally located, may liaise with local AF instances (e.g. AF 1 and AF 2) to relay the data traffic routing information.

In other words, each (C)PLMN exposes the following information for AF1 to collect and pass on to AF2 for HPLMN to make use of those configuration details for making application traffic routing decisions:
i) List of MEC Applications or AF Service Identifier that are supported per geographical location (e.g., per cell, per gNB or per TA) per (C)PLMN,
ii) Current running states of each MEC Application, e.g., onboarded, instantiated and the like,
iii) Active user information (e.g., GPSIs) that uses a particular MEC Application instance per PLMN per geographical location (e.g., per cell, per gNB or per TA),
iv) Current load level, residual capacity and QoS KPIs supported by each MEC Application instance, per (C)PLMN per geographical location (e.g., per cell, per gNB or per TA),
v) Address information (e.g., FQDN, IP addresses, port number) to reach a given MEC Application Instance.

Various example embodiments disclose devices, methods, and computer programs for routing data traffic of a UE to an edge application server of another PLMN in a non-roaming scenario, where connection to the other PLMN is maintained through the RAN of the HPLMN. This enables co-operation between different MNOs, for example, when providing time critical applications in geographical areas is not possible because of lack of required MEC infrastructure and resources for all MNOs.

FIG. 8 illustrates an example of a method for data traffic routing, according to an embodiment of the present disclosure. The method may be implemented, for example, by the H-PCF 132 or a H-NEF.

At 801, the method may comprise obtaining, at a home public land mobile network, configuration data associated with data traffic of at least one user equipment at a geographical area, the configuration data comprising a mapping of the data traffic to an identifier of at least one co-located public land mobile network providing access to an edge application server at the geographical area.

At 802, the method may comprise causing routing of the data traffic to the co-located public land mobile network based on the configuration data.

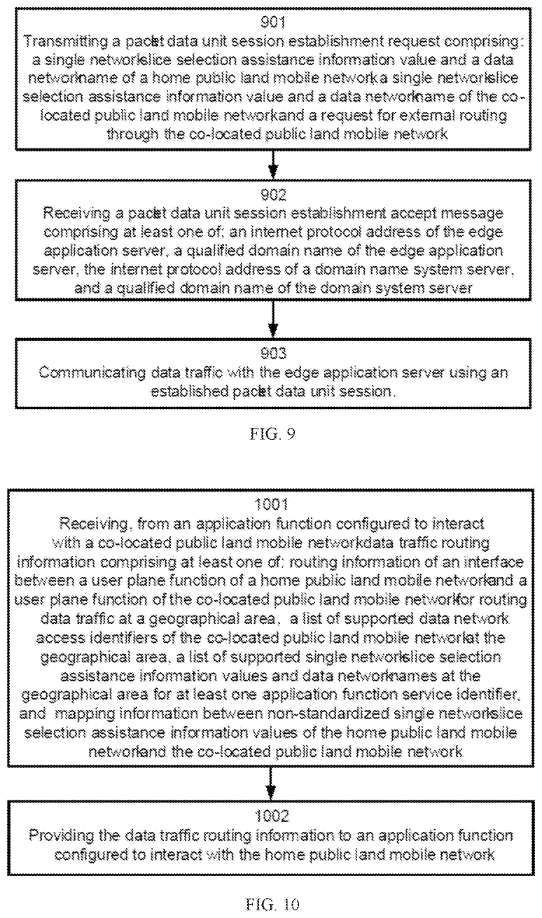

FIG. 9 illustrates an example of a method for accessing an edge application server of a co-located public land mobile network, according to an embodiment of the present disclosure. The method may be implemented, for example, by the UE 110.

At 901, the method may comprise transmitting a packet data unit session establishment request comprising: a single network slice selection assistance information value and a data network name corresponding to a home public land mobile network, a single network slice selection assistance information value and a data network name corresponding to the co-located public land mobile network, and a request for external routing through the co-located public land mobile network.

At 902, the method may comprise receiving a packet data unit session establishment accept message comprising at least one of an Internet protocol address of the edge application server, a fully qualified domain name of the edge application server, the Internet protocol address of a domain name system server, and a fully qualified domain name of the domain system server.

At 903, the method may comprise communicating data traffic with the edge application server using an established packet data unit session.

FIG. 10 illustrates an example of a method for enabling data traffic routing, according to an embodiment of the present disclosure. The method may be implemented, for example, by the federated AF manager 150.

At 1001, the method may comprise receiving, from an application function configured to interact with a co-located public land mobile network, data traffic routing information comprising at least one of routing information of an interface between a user plane function of a home public land mobile network and a user plane function of the co-located public land mobile network for routing data traffic at a geographical area, a list of supported AF-Service-Identifiers or data network access identifiers of the co-located public land mobile network at the geographical area, a list of supported single network slice selection assistance information values and data network names at the geographical area for at least one application function service identifier, and mapping information between non-standardized single network slice selection assistance information values of the home public land mobile network and the co-located public land mobile network.

At 1002, the method may comprise providing the data traffic routing information to an application function configured to interact with the home public land mobile network.

Further features of the methods directly result, for example, from functionalities of one or more of the network functions of the HPLMN 130 and/or the CPLMN 140, the UE 110, the application functions (AF1 or AF 2), and/or the federated AF manager 150, as described throughout the specification and in the appended claims, and are therefore not repeated here. Different variations of the methods may be also applied, as described in connection with the various example embodiments.

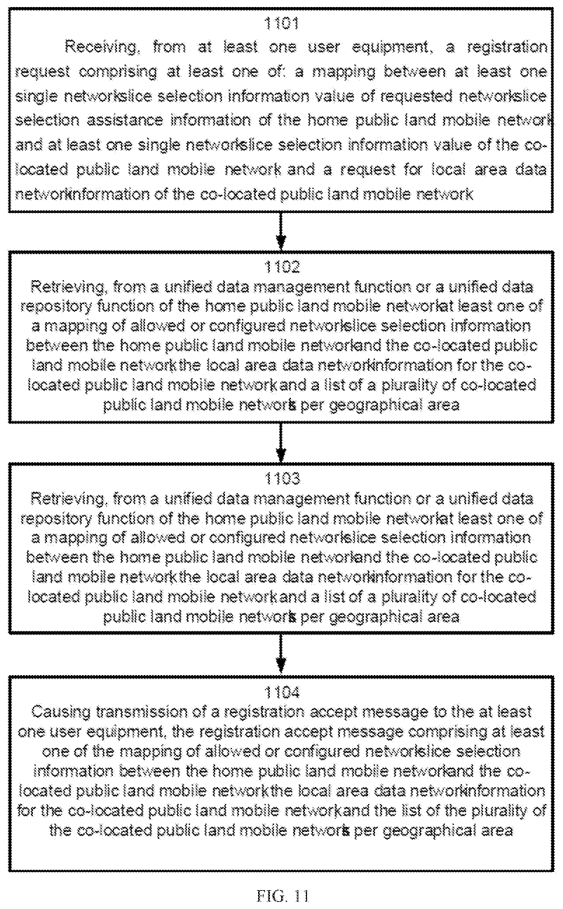

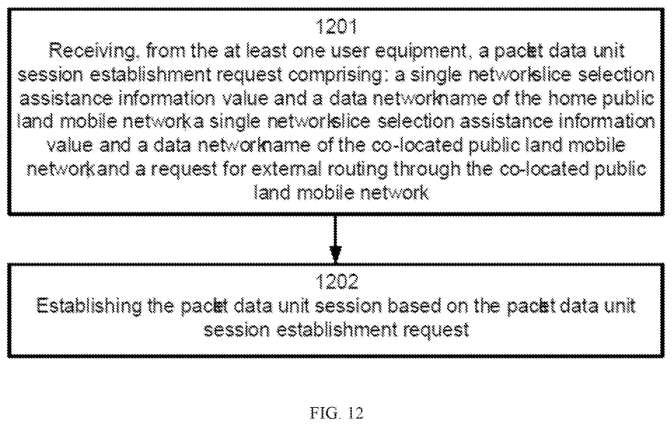

FIG. 11 illustrates an example of a method for data traffic routing, according to an embodiment of the present disclosure. The method may be implemented, for example, by the H-AMF 131.

At 1101, the method may comprise receiving, from at least one user equipment, a registration request comprising at least one of a mapping between at least one single network slice selection information value of requested network slice selection assistance information of the home public land mobile network and at least one single network slice selection information value of the co-located public land mobile network, and a request for local area data network information of the co-located public land mobile network.

At 1102, the method may comprise retrieving, from a unified data management function or a unified data repository function of the home public land mobile network, at least one of a mapping of allowed or configured network slice selection information between the home public land mobile network and the co-located public land mobile network, the local area data network information for the co-located public land mobile network, and a list of a plurality of co-located public land mobile networks per geographical area.

At 1103, the method may comprise causing transmission of a registration accept message to the at least one user equipment, the registration accept message comprising at least one of the mapping of allowed or configured network slice selection information between the home public land mobile network and the co-located public land mobile network, the local area data network information for the co-located public land mobile network, and the list of the plurality of the co-located public land mobile networks per geographical area.

FIG. 12 illustrates an example of a method for data traffic routing, according to an embodiment of the present disclosure. The method may be implemented, for example, by the H-SMF 134.

At 1201, the method may comprise receiving, from the at least one user equipment, a packet data unit session establishment request comprising: a single network slice selection assistance information value and a data network name of the home public land mobile network, a single network slice selection assistance information value and a data network name of the co-located public land mobile network, and a request for external routing through the co-located public land mobile network.

At 1202, the method may comprise establishing the packet data unit session based on the packet data unit session establishment request.

A device or a node, such as, for example, a network device or a network node configured to implement one or more network functions, may be configured to perform or cause performance of any aspect of the method(s) described herein. Further, a computer program or a computer program product may comprise instructions for causing, when executed, a device to perform any aspect of the method(s) described herein. Further, a device may comprise means for performing any aspect of the method(s) described herein. According to an example embodiment, the means may comprise at least one processor, and memory including program code, the at least one processor, and program code configured to, when executed by the at least one processor, cause the device to perform any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the example embodiments described above may be combined with aspects of any of the other example embodiments described to form further example embodiments without losing the effect sought.

The term ‘comprising’ is used herein to mean including the method, blocks, or elements identified, but that such blocks or elements do not comprise an exclusive list and a method or apparatus may contain additional blocks or elements.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A device fem sing:
at least one memory configured to store program code; and
at least one processor coupled to the at least one memory and configured to execute the program code to cause the device to:
obtain, at a home public land mobile network, configuration data associated with data traffic of a user equipment at a geographical area, wherein the configuration data comprise a first mapping of the data traffic to an identifier of a co-located public land mobile network configured to provide access to an edge application server at the geographical area; and
case routing of the data traffic to the co-located public land mobile network based on the configuration data.

2. The device of claim 1, wherein the at least one processor is further configured to execute the program code to cause the device to receive, from an application function, application function request comprising the configuration data.

3. The device of claim 1, wherein the at least one processor is further configured to execute the program code to cause the device to identify the data traffic based on a data network name, a single network slice selection assistance information value, or an application function service identifier.

4. The device of claim 1, wherein the configuration data further comprise a supported data network name, a supported data network access identifier, a traffic routing requirement for the supported data network access identifier, a fully qualified domain name of the edge application server, an Internet Protocol address of the edge application server, or a requirement for routing the data traffic through a shortest path to the edge application server via a user plane function of the home public land mobile network.

5. The device of claim 1, wherein the device is a network exposer function of the home public land mobile network or a policy control function of the home public land mobile network.

6. The device of claim 5, wherein the at least one processor is further configured to execute the program cod to cause the device to:
determine, based on the configuration data, policy and charging control rules for a session management function of the home public land mobile network, wherein the policy and charging control rules enable selection of a user plane function of the co-located public land mobile network for routing the data traffic to the edge application server; and
provide the policy and charging control rules to the session management function.

7. The device of claim 6, wherein the configuration data further comprise a supported data network access identifier, and wherein the policy and charging control rules comprise a second mapping between the supported data network access identifier and the identifier for a given service data flow.

8. The device of claim 5, wherein the at least one processor is further configured to execute the program cod to cause the device to:
determine, based on the configuration data, access and mobility related policy information for an access and mobility management function of the home public land mobile network, wherein the access and mobility related policy information enables selection of a session management function of the co-located public land mobile network; and
provide the access and mobility related policy information to the access and mobility management function.

9. The device of claim 8, wherein the access and mobility related policy information comprises of an allowed co-located public land mobile network associated with a tracking arm identifier for the user equipment.

10. The device of claim 9, wherein the access and mobility related policy information further comprises a second indication of a supported single network slice selection assistance information value, wherein the second indication is associated with the co-located public land mobile network, and wherein the co-located public land mobile network is associated with the at least one tracking area identifier to route a given traffic type of the user equipment.

11. The device of claim 8, wherein the access and mobility related policy information comprises a second mapping among the identifier, a supported data network name, and a supported data network access identifier.

12. The device of claim 9, wherein the configuration data further comprises a data network name, and wherein the processor is further configured to execute the program code to cause the device to:
determine user equipment route selection policy information comprising a request for external routing of the data traffic through the co-located public land mobile network and comprising a route selection descriptor, wherein the route selection descriptor comprises a single network slice selection assistance information value or the data network name and comprises a second mapping between either the tracking area identifier or registration area identifier and either the single network slice selection assistance information value or the data network name; and
cause transmission of the user equipment route selection policy information to the user equipment.

13. A device comprising:
at least one memory configured to store program code; and
at least one processor coupled to the at least one memory and configured to execute the program code to cause the device to:
receive, from a user equipment, a registration request comprising a first mapping or a request for local area data network information of a co-located public land mobile network, wherein the first mapping is between a first single network slice selection information value of requested network slice selection assistance information of a home public land mobile network and a second single network slice selection information value of the co-located public land mobile network;
retrieve, from a unified data management function of the home public land mobile network or a unified data repository function of the home public land mobile network, a second mapping of allowed network slice selection information or configured network slice selection information between the home public land mobile network and the co-located public land mobile network, the local area data network information, and a list of a co-located public land mobile networks per geographical area; and
transmit, to the user equipment, of a registration accept message comprising the second mapping, the local area data network information and the list.

14. The device of claim 13, wherein the device is an access and mobility management function of the home public land mobile network.

15. The device of claim 14, wherein the processor is further configured to execute the program code to cause the device to:
provide, to a network repository function of the home public land mobile network, a network function discovery request comprising a first identifier of the co-located public land mobile network and a single network slice selection assistance information value that is of the co-located public land mobile network and that is associated with data traffic; and
receive a network function discovery request response comprising a second identifier of a session management function of the co-located public land mobile network.

16. A method comprising:
obtaining, at a home public land mobile network, configuration data associated with data traffic of a user equipment at a geographical area, wherein the configuration data comprise a first mapping of the data traffic to an identifier of a co-located public land mobile network providing access to an edge application server at the geographical area; and
causing routing of the data traffic to the co-located public land mobile network based on the configuration data.

17. The method of claim 16, further comprising receiving, from an application function, an application function request comprising the configuration data.

18. The method of claim 16, further comprising identifying the data traffic based on a data network name, a single network slice selection assistance information value, or an application function service identifier.

19. The method of claim 16, wherein a network exposure function of the home public land mobile network or a policy control function of the home public land mobile network implements the method.

20. The method claim 19, further comprising:
determining, based on the configuration data, policy and charging control rules for a session management function of the home public land mobile network, wherein the policy and charging control rules enable selection of a user plane function of the co-located public land mobile network for routing the data traffic to the edge application server; and
providing the policy and charging control rules to the session management function.
